(19) United States
(12) Patent Application Publication
(10) Pub. No.: US 2013/0035812 A1
(43) Pub. Date: Feb. 7, 2013

(54) BATTERY CHARGING SYSTEM AND METHOD

(71) Applicant: Adam D. Bernard, Royal Oak, MI (US)

(72) Inventor: Adam D. Bernard, Royal Oak, MI (US)

(73) Assignee: GM GLOBAL TECHNOLOGY OPERATIONS LLP, Detroit, MI (US)

(21) Appl. No.: 13/198,346

(22) Filed: Aug. 4, 2011

(51) Int. Cl. G06F 7/00

(52) U.S. Cl. 701/22

(57) ABSTRACT

A battery charging system for an electrically-powered vehicle comprises an operator interface and a battery configured to power the vehicle and receive a charge from an off-board charging source. The interface is configured to receive an operator input defining a desired vehicle range and to provide it to the charging controller. The charging controller is configured to receive the operator input, to predict a charging duration based on the operator input, to provide the estimated charging duration to the operator interface for presentation to the operator, and to affect duration of the charge in response to the operator input. A method of charging a battery comprises receiving an operator input defining a desired vehicle range, predicting an estimated charging duration based on the operator input, presenting the estimated charging duration to the operator, and affecting the charging duration based on the operator input.

### FIELD OF THE INVENTION

The subject invention relates generally to a battery charging system for an electrically-powered vehicle and more specifically to a charging system that estimates a charging duration for the vehicle in response to an operator's indication of a desired vehicle range or destination.

### BACKGROUND

In today's world, a vehicle deriving some or all of its power from an on-board electric storage device (i.e., a battery) may need to be re-charged periodically from an off-board charging source such as a utility grid or another energy source. The amount of time required to acquire such a re-charge (i.e., the charging duration) from an off-board charging source depends upon a number of factors including the amount of charge to be acquired (i.e., the charging quantity), the availability of an off-board charging source, characteristics of the off-board charging source (e.g., the rate at which it can provide a charge, i.e., the charging rate), and characteristics of the on-board battery or batteries (e.g., the rate at which they can accept a charge). The cost associated with re-charging (i.e., the charging cost) may depend upon the charging quantity and other factors such as the location of the off-board charging source (i.e., the charging location) and the time at which the charge is to be acquired (i.e., the charge time).

The charging duration required to restore a battery for an electric vehicle to a fully charged state has been known to exceed eight hours. Situations may arise when a lengthy charging duration might be extremely inconvenient for an operator, such as when the operator has an urgent need to use the vehicle and/or when or where availability of an off-board charging source is limited or costly. Accordingly, an operator may wish to study alternatives to obtaining a full charge. Moreover, consistent with the practice of electric utilities to vary energy rates seasonally or even daily, charging providers may manipulate charging costs so as to encourage charging at off-peak times and to discourage charging at times of peak use. Similarly, energy providers in busy locations may assess premium rates for access to charging services. Accordingly, an operator may wish to consider alternate charging locations and/or charge times.

Accordingly, it is desirable to provide an invention that can facilitate an operator's management of charging duration, charging location, charge time, and/or charging cost associated with the operator's electrically powered vehicle and the operator's specification of desired range and/or destination information. It is also desirable to provide an invention that can provide information such as charging duration and charging cost to a vehicle operator to facilitate improved management of the operator's time and financial resources.

### SUMMARY OF THE INVENTION

In one exemplary embodiment of the invention, a battery charging system for an electrically-powered vehicle comprises an operator interface and a battery configured to power the vehicle and receive a charge from an off-board charging source. In accordance with this embodiment, the operator interface is configured to receive an operator input defining a desired vehicle range and to provide it to a charging controller. The charging controller is configured to receive the operator input, to predict a charging duration based on the operator input, to provide the estimated charging duration to the operator interface for presentation to the operator, and to affect duration of the charge in response to the operator input.

In another exemplary embodiment of the invention, a method for charging a battery comprises receiving an operator input defining a desired vehicle range, predicting an estimated charging duration based on the operator input, presenting the estimated charging duration to the operator, and affecting the charging duration based on the operator input.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a schematic diagram of an exemplary system for charging an electrically-powered vehicle;

FIG. 2 is a flow chart depicting an exemplary method for charging a battery of an electrically-powered vehicle; and

FIG. 3 is an illustration of an exemplary operator interface for a system for charging an electrically-powered vehicle.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

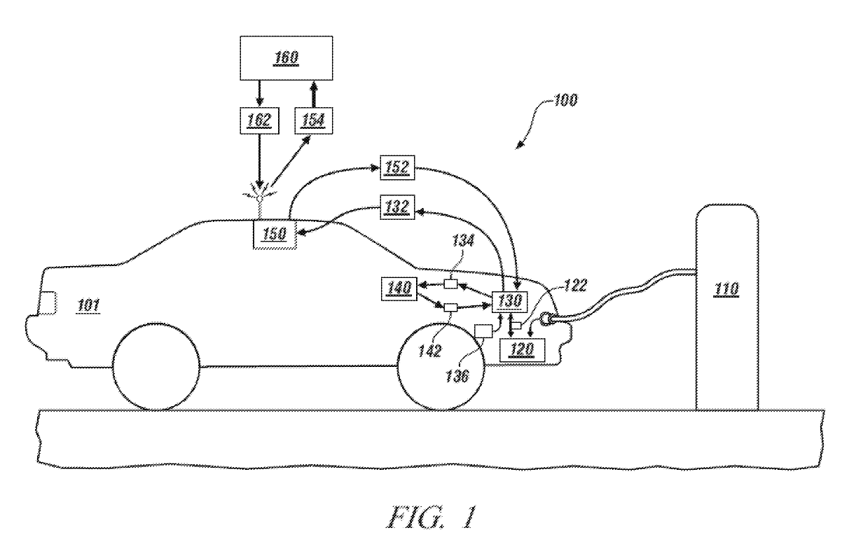

In accordance with an exemplary embodiment of the invention, and as shown in FIG. 1, an exemplary system 100 for charging a battery 120 of an electrically-powered vehicle 101 includes a charging controller 130 that is associated with vehicle 101 and that communicates with an operator via an operator interface 140 (e.g., interactive display, indictors, gauges, switches, knobs, touch screen, voice, buttons, dials, and the like) associated with the vehicle. Battery 120 is configured to power vehicle 101 and to receive a charge from an off-board charging source 110, subject to action of charging controller 130.

Operator interface 140 is configured to receive operator input and to make it available for use by a charging controller 130 that is associated with vehicle 101. In an exemplary embodiment, operator interface 140 is a vehicle onboard navigation system and provides charging information 134 to the operator and enables the operator to provide charging preference information 142 to charging controller 130. Through operation of charging controller 130, charging preference information 142 may affect the extent to which battery 120 is to be charged. Charging controller 130 also uses charging preference information 142 to create charging information 134, which operator interface 140 can present to the operator so as to enable the operator's improved management of time and financial resources.

Charging controller 130 is configured to receive the operator input contained in charging preference information 142 and to use that information to predict an estimated charging duration based at least in part on the operator input. In an exemplary embodiment, operator input defines a desired vehicle range, for example, by defining a specific destination. In an exemplary embodiment, the estimated charging duration represents an amount of time that is predicted to be required for the battery to receive a charging quantity sufficient to enable the vehicle to achieve the desired range or to reach the desired destination. When the charging quantity required to reach a desired destination is less than a full charge, charging controller 130 may also be configured to affect the duration of the charge in response to the operator input (e.g., by limiting the charging duration to only the length of time necessary to enable the vehicle to reach the destination) and to provide the estimated charging duration to the operator interface 140 for presentation to an operator.

Charging controller 130 may also communicate with a remote facility 160 via communications module 150, which may send and receive information to and from a remote correspondent in any suitable, known fashion (e.g., transceiver, an OnStar communication system, cell phone) and may also store information for later use. To communicate with remote facility 160, charging controller 130 provides on-board information 132 to communications module 150, which transmits relayed on-board information 154 for receipt by remote facility 160. Communications module 150 also receives off-board information 162 from remote facility 160, and transmits relayed off-board information 152 for use by charging controller 130. In an exemplary embodiment, charging controller 130 communicates with remote facility 160 via communications module 150, which may be a communication system such as an OnStar communication system. Charging controller 130 may also receive information from a number of other sources including battery information 122 from battery 120 or another source.

Battery information 122 may comprise information such as battery type, battery performance characteristics, battery state of charge, battery storage capacity, battery temperature, current draw, voltage, and other parameters of interest that are related to the battery. On-board information 132 may include any battery information 122 as well as other vehicle information 136 collected by charging controller 130 such as location, accessory settings, historical power usage, ambient temperature, humidity, elevation, and charging preference information 142. Charging preference information 142 may include operator-provided information such as charging control mode, desired range or destination, available funds for charging, available time for charging, anticipated accessory usage, an operator's desire to determine the earliest time of arrival at the desired vehicle destination, an operator's desire to minimize charging duration, and/or other parameters that may affect charge required to reach a destination.

Charging information 134 may include information useful to an operator such as required charging duration, anticipated charging cost, available vehicle range, likelihood that the available charge will enable the vehicle to reach the prescribed destination, and other information useful to an operator. Relayed on-board information 154 may include on-board information 132. Off-board information 162 may include information useful for planning a charging agenda such as locations, availabilities, wait times, and charging costs associated with other charging facilities. Off-board information 162 may also include updated algorithms/software periodically. Relayed off-board information 152 includes off-board information 162.

In an exemplary embodiment, battery 120 receives energy from (i.e., is charged by) charging source 110, and charging controller 130 may control the receipt of charging energy received by battery 120. For example, upon receipt of battery information 122 and charging preference information 142, and relayed off-board information 152, charging controller 130 produces on-board information 132 and charging information 134 and executes control of the charging of battery 120 according to algorithms used by charging controller 130. Periodically, a new algorithm may be communicated to charging controller 130 from remote facility 160.

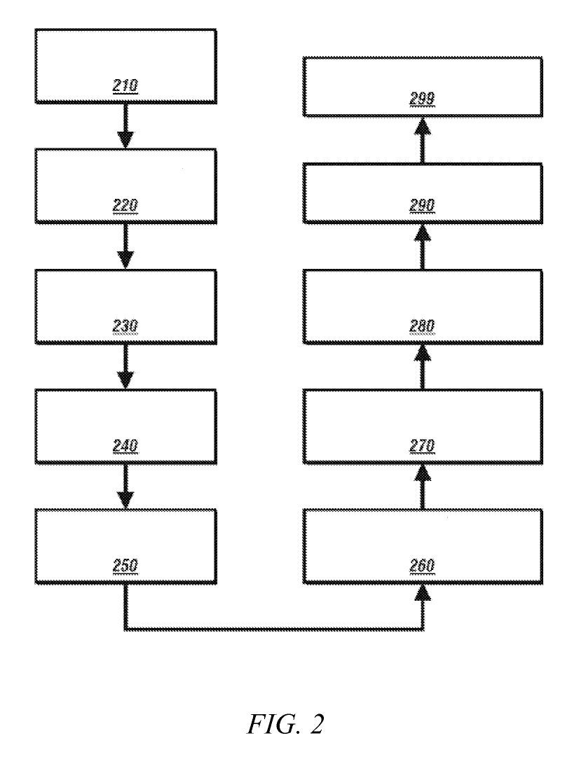

FIG. 2 shows an exemplary method 200 for charging a battery of an electrically-powered vehicle. As shown in FIG. 2, at operation 210, interface information is received from an operator interface. The information may define a desired destination and may include charging preference information. At operation 220, on-board information is received defining a current location of the vehicle and may include other vehicle information as described herein. At operation 230, off-board information is received including traffic, weather conditions, locations of intermediate charging stations terrain, and may include relayed off-board information.

Once the necessary information has been acquired, at step 240, the system determines a required charge. In an exemplary embodiment, the system uses software to interpret the relevant information and determine the charge required to enable the vehicle to reach the prescribed destination, accounting for traffic, weather, accessory use, and other relevant considerations. This may be accomplished using any suitable technique based on, for example, experience with charge use as a function of distance, weather, traffic, battery temperature, and other relevant information.

At operation 250, the system calculates how much time is needed (i.e., the minimum charging duration) to acquire the required charge determined at operation 240. This predicted charging duration is based on an amount of charge required as well as historical data stored by the system. That data may include experienced charging rates and energy usage. At operation 260, required charging and required charging duration are transmitted and displayed by the interface for use by an operator. The display of this information enables the operator to know how long the vehicle needs to be plugged in before the operator may depart for the prescribed destination. Based on this information, the operator may revise the information provided to the interface such that operations 210 through 260 may be repeated.

At operation 270, the state of charge of the battery may be monitored during charging so that, at operation 280, an actual rate of charge may be determined based on changes in state of charge during charge. This information may enable operation 250 to be repeated so as to revise the calculation of charging duration needed to acquire the required charge determined at operation 240. At operation 290, charging performance may be tracked so as to maintain and update a charging history for use in operation of the system. Finally, at operation 299, the system may terminate charging when a sufficient charge has been acquired or when commanded by an operator via the interface.

As a consequence, the system and method enables an operator to make informed choices as to whether and when to reduce the amount of time devoted to charging the vehicle at a particular moment in time. This enables an operator to charge a battery only as much as needed to meet a projected need, such as reaching a particular location, which may also improve battery life by preventing over-charging.

The operations disclosed herein may be performed by a processing device used by charging controller 130 or operator interface 140 or remote facility 160 and may be performed on-board vehicle 101 or may be performed off-board vehicle 101 and communicated to vehicle 101 such as through an OnStar communication system. Information may be stored in many forms including, but not limited to, non-writable storage media such as ROM devices and/or writeable storage media such as floppy disks, magnetic tapes, CDs, RAM devices, and other magnetic and optical media. Algorithms for accomplishing operations described herein may be embodied in whole or in part as executable software objects or as hardware components, such as Application Specific Integrated Circuits (ASICs) or other hardware components or devices, or a combination of hardware, software and firmware components.

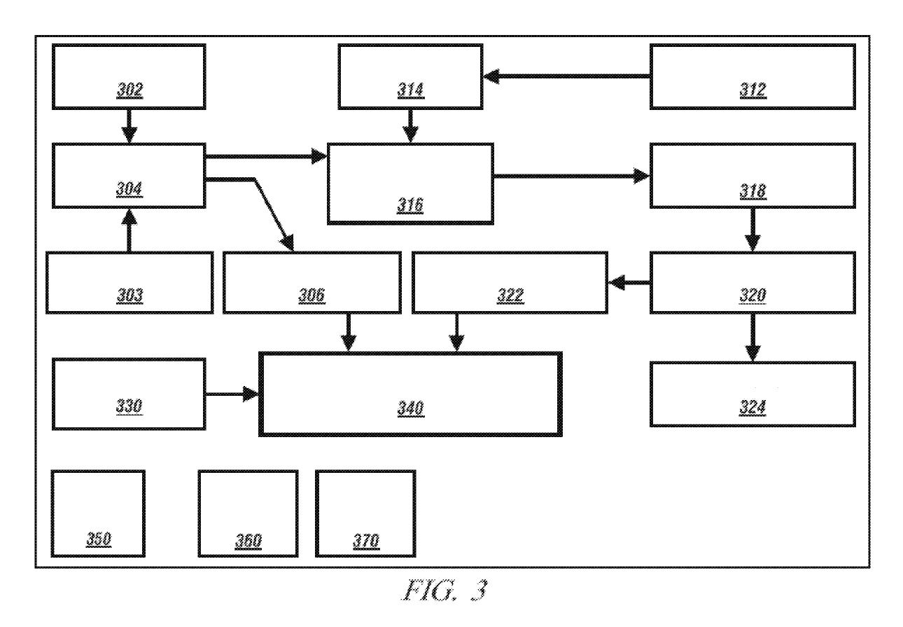

Referring now to FIG. 3, an example of an operator interface 300 is shown in greater detail. Virtual buttons are provided that enable the operator to interact with the charging system, specifying an operation or planning mode 350 (e.g., “FAST CHARGE MODE” or “MINIMUM COST MODE” or “SOONEST ARRIVAL MODE”), reviewing or comparing displayed charging source identities or information 360, selecting one or more charging source 370, and/or providing or selecting a destination 303 (e.g., “DESTINATION=123 East Main Street, Anytown, 98765”), to discover or compare or select charging sources, and/or to prescribe a range (e.g., “DESIRED RANGE=22 MILES”). In other embodiments, other different features/options may also be provided.

In an exemplary embodiment, operator interface 300 displays a current location 302 and a current state of charge 312. Based on the state of charge 312 and information known about vehicle performance, traffic, weather, and other information, a current range 314 may also be displayed. Based on the operator's selected or defined planned destination 303, a distance 304 and an estimated travel time 306 are calculated and may be displayed. In addition, based on the current range estimation 314 and the calculated distance 304 to the prescribed destination 303, a range surplus/deficiency 316 may be displayed.

If there is a range deficiency, indicating that a charge would be required in order to travel to the prescribed destination, the interface may display a minimum charge required 318. Depending upon the operational mode, the operator or the system may define a planned charging quantity 320, which will be used, along with charging rate information associated with the battery and the charging facility, to determine an estimated charging duration 322. Based on the estimated charging duration 322, the travel time 306 and the current time 330, an estimated time of arrival 340 may be determined and displayed for use by the operator. Also, based on the planned charging quantity 320 and energy cost information associated with the selected charging source, an estimated charging cost 324 may be displayed.

Constrained by limitations on time and funds, an operator of an electrically powered vehicle may desire to reduce the charging duration and/or the charging cost associated with a particular charging event. For example, the operator may desire to spend only enough time charging the vehicle to enable driving to a desired location such as home or another charging location. Alternatively, the operator may desire to spend only enough money charging the vehicle to enable driving to a desired location such as home or another charging location. The invention provides a system and method for realizing these and other benefits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A battery charging system for an electrically-powered vehicle, the charging system comprising:
one or more operator interface associated with the vehicle and configured to receive an operator input and to provide the operator input to at least one charging controller associated with the vehicle; and
at least one battery configured to power the vehicle and to receive a charge from an off-board charging source;
wherein the charging controller is configured to receive the operator input, to predict an estimated charging duration based at least in part on the operator input, to affect the a duration of the charge in response to the operator input, and to provide the estimated charging duration to the operator interface for presentation to an operator;
wherein the operator interface is configured to receive the estimated charging duration from the charging controller and to present the estimated charging duration to an operator; and
wherein the operator input defines a desired vehicle range.

2. A charging system as in claim 1, wherein the operator input defines an operator's desire to minimize charging duration.

3. A charging system as in claim 1, wherein the operator input defines an operator's planned use of one or more power-consuming accessories.

4. A charging system as in claim 1, wherein the operator input defines a desired vehicle destination.

5. A charging system as in claim 4, wherein the operator input defines an operator's desire to determine the earliest time of arrival at the desired vehicle destination.

6. A charging system as in claim 1, wherein the charging controller is configured to receive battery information and to predict the estimated charging duration based at least in part on the battery information.

7. A charging system as in claim 6, wherein the battery information comprises a current state of charge.

8. A charging system as in claim 6, wherein the battery information comprises a battery storage capacity.

9. A charging system as in claim 6, wherein the battery information comprises a battery performance estimate.

10. A charging system as in claim 1, wherein the charging controller is configured to receive on-board information from an on-board source and to predict the estimated charging duration based at least in part on the on-board information.

11. A charging system as in claim 10, wherein the on-board information comprises a current location of the vehicle.

12. A charging system as in claim 10, wherein the on-board information comprises a historical rate of power usage associated with the vehicle.

13. A charging system as in claim 1, wherein the charging controller is configured to receive off-board information from an off-board source and to predict the estimated charging duration based at least in part on the off-board information.

14. A charging system as in claim 13, wherein the off-board information comprises weather information.

15. A charging system as in claim 13, wherein the off-board information comprises traffic information.

16. A charging system as in claim 13, wherein the off-board information comprises location information associated with at least one alternate charging source.

17. A charging system as in claim 16, wherein the off-board information comprises energy cost information associated with at the least one alternate charging source.

18. A charging system as in claim 16, wherein the off-board information comprises availability information associated with at the least one alternate charging source.

19. A charging system as in claim 16, wherein the off-board information comprises charging rate information associated with at the least one alternate charging source.

20. A method of charging a battery of an electrically powered vehicle, the method comprising:
receiving an operator input defining a desired vehicle range;
predicting an estimated charging duration based at least in part on the operator input;
presenting the estimated charging duration to the operator, and
affecting the charging duration based on the operator input.
